(19) United States
(12) Patent Application Publication
(10) Pub. No.: US 2025/0079879 A1
(43) Pub. Date: Mar. 6, 2025

(54) SOLAR CHARGING SYSTEM

(71) Applicant: TOYOTA JIDOSHA KABUSHIKI KAISHA, Toyota-shi (JP)

(72) Inventor: Yukinori MURAKAMI, Toyota-shi (JP)

(73) Assignee: TOYOTA JIDOSHA KABUSHIKI KAISHA, Toyota-shi (JP)

(21) Appl. No.: 18/663,447

(22) Filed: May 14, 2024

(30) Foreign Application Priority Data
Aug. 30, 2023 (JP) 2023-139992

(51) Int. Cl. H02J 7/35; B60L 53/51; H02S 10/00; H02S 50/10

(52) U.S. Cl. CPC H02J 7/35; H02S 10/00; H02S 50/10; B60L 53/51

(57) ABSTRACT

A solar charging system including a plurality of solar modules that generate power using solar light, wherein at least one of the plurality of solar modules includes a master solar panel, a sensor that acquires a power generation state of the master solar panel, an instruction unit that instructs power generation control of the master solar panel based on a power generation state acquired by the sensor, and a master power generation control unit that controls power generation of the master solar panel according to an instruction from the instruction unit, and the slave solar modules other than the master solar modules among the plurality of solar modules each include a slave solar panel and a slave power generation control unit that controls power generation of the slave solar panels using an instruction from the instruction unit of the master solar module.

### CROSS-REFERENCE TO RELATED APPLICATION

This application claims priority to Japanese Patent Application No. 2023-139992 filed on Aug. 30, 2023, incorporated herein by reference in its entirety.

### BACKGROUND

### 1. Technical Field

The present disclosure relates to a solar charging system mounted on a vehicle etc.

### 2. Description of Related Art

Japanese Unexamined Patent Application Publication No. 2020-141545 (JP 2020-141545 A) discloses an in-vehicle solar charging system provided with a plurality of solar panels. In the solar charging system described in JP 2020-141545 A, each solar control device provided for each solar panel performs Maximum Power Point Tracking (MPPT) control on the solar panel to be controlled by the device. The MPPT control is performed to search for a maximum power point with high accuracy when an output voltage of the solar panel changes due to an environmental change such as a change in a solar radiation condition. In the MPPT control, a scanning process for scanning the output voltage of the solar panel is performed to search for an optimal point on a P-V curve.

### SUMMARY

The solar charging system described in JP 2020-141545 A is configured such that a plurality of solar control devices controls the respective solar panels. In such a configuration, components such as a sensor for acquiring a power generation state of the solar panel and a configuration for performing the scanning process are required for each solar panel. Therefore, in a solar charging system including a plurality of solar panels as disclosed in JP 2020-141545 A, problems such as an increase in system cost and an increase in system scale (number of elements) remain.

The present disclosure has been made in view of the above issue. An object of the present disclosure is to reduce the number of components used for power generation control on solar panels in a system including a plurality of solar panels, thereby reducing the cost and the scale of the system.

In order to solve the above issue, an aspect of the disclosed technology provides a solar charging system including a plurality of solar modules configured to generate electric power using sunlight.

At least one master solar module among the plurality of solar modules includes a master solar panel,
a sensor configured to acquire a power generation state of the master solar panel, an instruction unit configured to give an instruction for power generation control on the master solar panel based on the power generation state acquired by the sensor, and
a master power generation control unit configured to control power generation of the master solar panel in accordance with the instruction from the instruction unit.

Each slave solar module other than the master solar module among the plurality of solar modules includes
a slave solar panel, and
a slave power generation control unit configured to control power generation of the slave solar panel by using an instruction from the instruction unit of the master solar module.

According to the present disclosure, the number of components such as sensors used for the power generation control on the solar panels is reduced in the solar charging system including the plurality of solar panels. Thus, it is possible to reduce the cost and the scale of the solar charging system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration example of a solar charging system according to an embodiment of the present disclosure;

FIG. 2A is a schematic diagram illustrating an example in which a plurality of solar panels is mounted on vehicles in a multi-system configuration;

FIG. 2B is a diagram illustrating an example in which a plurality of solar panels is mounted on vehicles in a multi-junction configuration;

FIG. 3 is a block-diagram illustrating another schematic configuration of the solar charging system according to the present embodiment; and

FIG. 4 is a flowchart of scan process control performed by the solar charging system.

### DETAILED DESCRIPTION OF EMBODIMENTS

The solar charging system of the present disclosure includes a plurality of solar panels in a configuration. The solar charging system of the present disclosure also uses an indication of power generation control for a particular solar panel for power generation control of other solar panels that correlate to solar radiation conditions with this particular solar panel. By sharing the instruction of the power generation control with several solar panels in this way, it is possible to reduce a part of components such as a sensor which is conventionally installed for each solar panel.

Hereinafter, an embodiment of the present disclosure will be described in detail with reference to the drawings.

### EMBODIMENT

### Configuration

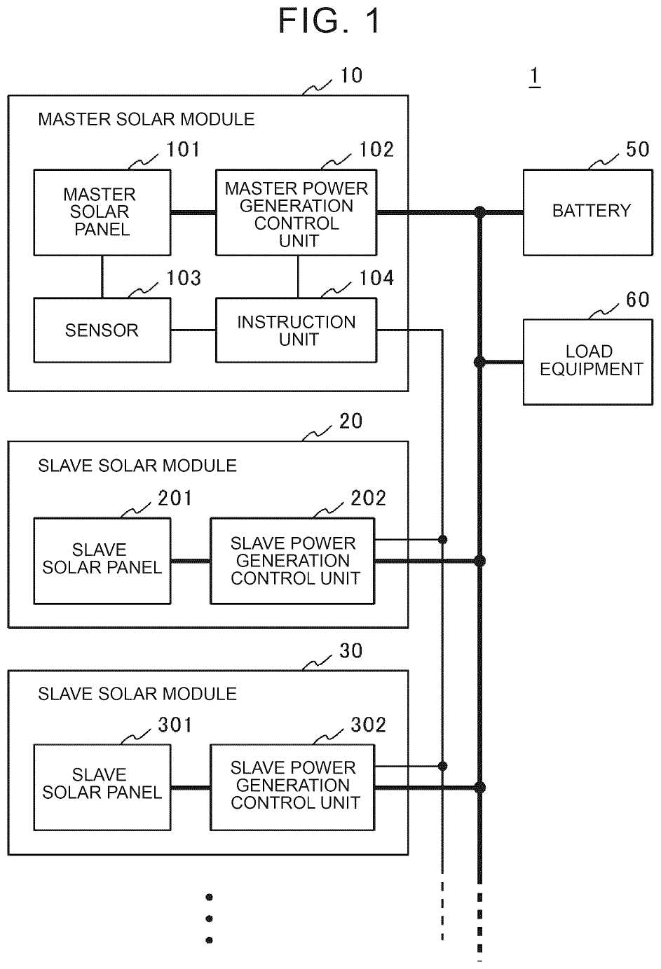

FIG. 1 is a block diagram illustrating a schematic configuration of a solar charging system 1 according to an embodiment of the present disclosure. The solar charging system 1 illustrated in FIG. 1 includes a master solar module 10, a plurality of slave solar modules 20 and 30, a battery 50, and a load device 60. In FIG. 1, a connection line through which electric power is transmitted is indicated by a thick solid line, and a connection line through which control signals, detection values, and the like other than electric power are transmitted and received is indicated by a thin solid line. The solar charging system 1 can be mounted on vehicles such as, for example, hybrid electric vehicle (HEV), plug-in hybrid electric vehicle (PHEV), and battery electric vehicle (BEV).

Each of the master solar module 10, the slave solar module 20, and the slave solar module 30 is a power generation device that generates electric power by being irradiated with sunlight. The master solar module 10 is the primary solar module that controls the operation of all solar modules. The slave solar module 20 and the slave solar module 30 are slave solar modules whose operation is controlled by the master solar module 10. The electric power generated by the master solar module 10, the slave solar module 20, and the slave solar module 30 is output to the battery 50, the load device 60, and the like connected to these solar modules.

The master solar module 10 includes a master solar panel 101, a master power generation control unit 102, a sensor 103, and an instruction unit 104 in a configuration.

The master solar panel 101 is a device capable of generating electric power according to the irradiation amount of sunlight, and is typically an aggregate of solar cells.

The master power generation control unit 102 is a configuration for controlling power generation of the master solar panel 101, and is typically a power converter such as a DCDC converter. The master power generation control unit 102 receives the power generated by the master solar panel 101, converts the input generated power into a predetermined voltage in accordance with an instruction (control) from the instruction unit 104, and outputs the voltage. The output of the master power generation control unit 102 is supplied to the battery 50 and the load device 60.

The sensor 103 is a configuration for acquiring a power generation state of the master solar panel 101. The sensor 103 can acquire physical quantities such as an output voltage, an output current, a temperature, and generated electric power of the master solar panel 101 as a power generation state. As the sensor 103, various detection elements such as a voltage sensor and a current sensor are used.

The instruction unit 104 is a configuration for controlling the master power generation control unit 102. The instruction unit 104 instructs control of the master power generation control unit 102 based on the power generation state of the master solar panel 101 acquired by the sensor 103. The control includes control for outputting a voltage command for power generation to DCDC of the converters constituting the master power generation control unit 102, and MPPT control for performing a scanning process for searching for the maximum power point of the master solar panel 101. The instruction unit 104 also instructs the slave solar module 20 and the slave solar module 30 to perform control instructed to the master power generation control unit 102.

The slave solar module 20 includes a slave solar panel 201 and a slave power generation control unit 202 in a configuration. The slave solar module 30 includes a slave solar panel 301 and a slave power generation control unit 302 in a configuration. In the present embodiment, all the slave solar modules included in the solar charging system 1 have the same configuration.

Each of the slave solar panel 201 and the slave solar panel 301 is a device capable of generating electric power according to the irradiation amount of sunlight, and is typically an aggregate of solar cells.

The slave power generation control unit 202 is a configuration for controlling power generation of the slave solar panel 201, and is typically a power converter such as a DCDC converter. The slave power generation control unit 202 inputs the power generated by the slave solar panel 201, converts the input generated power into a predetermined voltage in accordance with an instruction (control) received from the instruction unit 104 of the master solar panel 101, and outputs the voltage. The output of the slave power generation control unit 202 is supplied to the battery 50 and the load device 60.

The slave power generation control unit 302 is a configuration for controlling power generation of the slave solar panel 301, and is typically a power converter such as a DCDC converter. The slave power generation control unit 302 inputs the power generated by the slave solar panel 301, converts the input generated power into a predetermined voltage in accordance with an instruction (control) received from the instruction unit 104 of the master solar panel 101, and outputs the voltage. The output of the slave power generation control unit 302 is supplied to the battery 50 and the load device 60.

In the solar charging system 1 according to the present embodiment, the master solar panel 101, the slave solar panel 201, and the slave solar panel 301 have a predetermined correlation in a solar radiation situation. Examples of predetermined 25 correlations in this solar radiation situation include that the per sunlight of the master solar panel 101 matches or approximates the per sunlight of the slave solar panel 201 and the slave solar panel 301. Irradiation dose, irradiation angle, irradiation area, etc. are concretely the way of the sun. Further, examples of predetermined correlations in solar radiation situations include being able to infer the per sunlight of the master solar panel 101 to the per sunlight of the slave solar panel 201 and the slave solar panel 301.

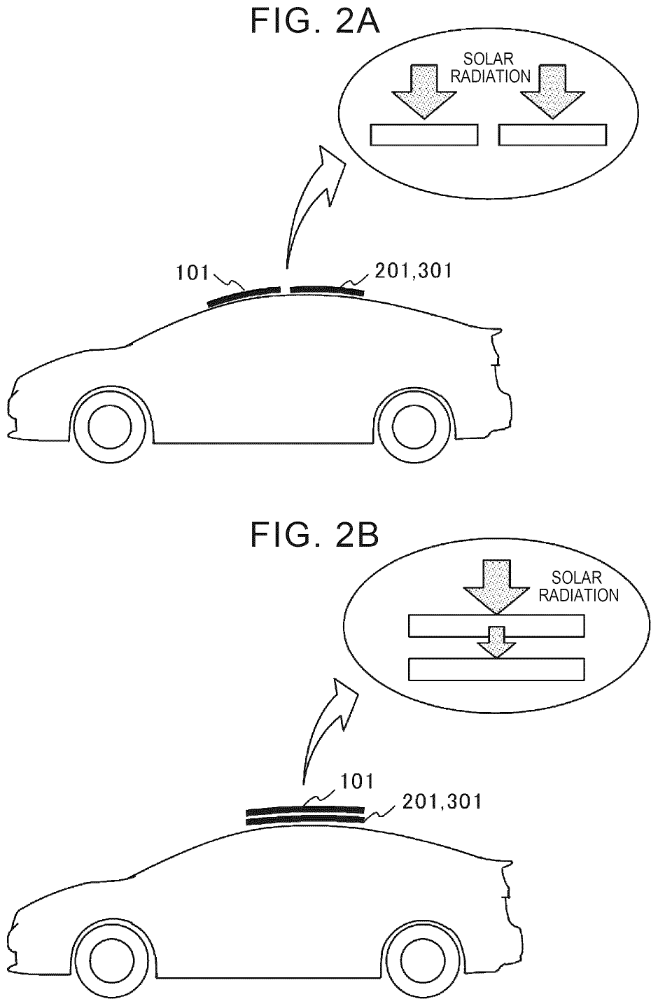

The master solar panel 101 and the slave solar panel 201 and the slave solar panel 301 may be arranged at different locations in a planar manner, or may be arranged at the same location in a three-dimensional manner. FIG. 2A shows an exemplary image of the master solar panel 101, the slave solar panel 201, and the slave solar panel 301 installed side by side on the roof of the vehicle (multi-system configuration). In FIG. 2B, the master solar panel 101, the slave solar panel 201, and the slave solar panel 301 are stacked on the roof of the vehicle (multi-junction structure). Examples of locations where solar panels are installed in vehicles include bonnets, back doors, trunks, and windows in addition to roofs.

For example, in the case of a multi-system structure, if the normal direction or curvature of the surface of the master solar panel 101 matches or approximates the normal direction or curvature of the surface of the slave solar panel 201 or the slave solar panel 301, it can be said that there is a correlation with the solar radiation situation. The multi-system structure is a structure as shown in FIG. 2A, and is a structure in which panels are arranged side by side at different locations. On the other hand, in the case of the multi-junction structure, since the normal direction and the curvature of the surface of the master solar panel 101 and the slave solar panel 201 and the slave solar panel 301 are already in agreement with each other, it can be said that there is a correlation with the solar radiation situation. The multi-junction structure is a structure as shown in FIG. 2B and is a structure in which the panels are laid over one another at the same location. However, in the case of such a multi-junction structure, the amount of light that passes through the master solar panel 101 and reaches the slave solar panel 201 and the slave solar panel 301 is smaller than the amount of light that is received by the master solar panel 101. Therefore, in order to estimate the amount of light received by the slave solar panel 201 and the slave solar panel 301 (or vice versa) from the amount of light received by the master solar panel 101, the light transmittance, the light attenuation rate, and the like of the master solar panel 101 may be grasped in advance.

The battery 50 is a secondary battery configured to be chargeable and dischargeable, such as a lithium ion battery or a lead storage battery. The battery 50 is connected to the master solar module 10, the slave solar module 20, and the slave solar module 30. The battery 50 is configured to be able to charge electric power generated by the master solar panel 101 via the master power generation control unit 102. Further, the battery 50 is configured to be able to charge electric power generated by the slave solar panel 201 via the slave power generation control unit 202. The battery 50 is configured to be able to charge electric power generated by the slave solar panel 301 via the slave power generation control unit 302.

The load device 60 is connected to the battery 50, and is a variety of devices that operate with electric power supplied from the battery 50. The load device 60 may not be included as a configuration of the solar charging system 1.

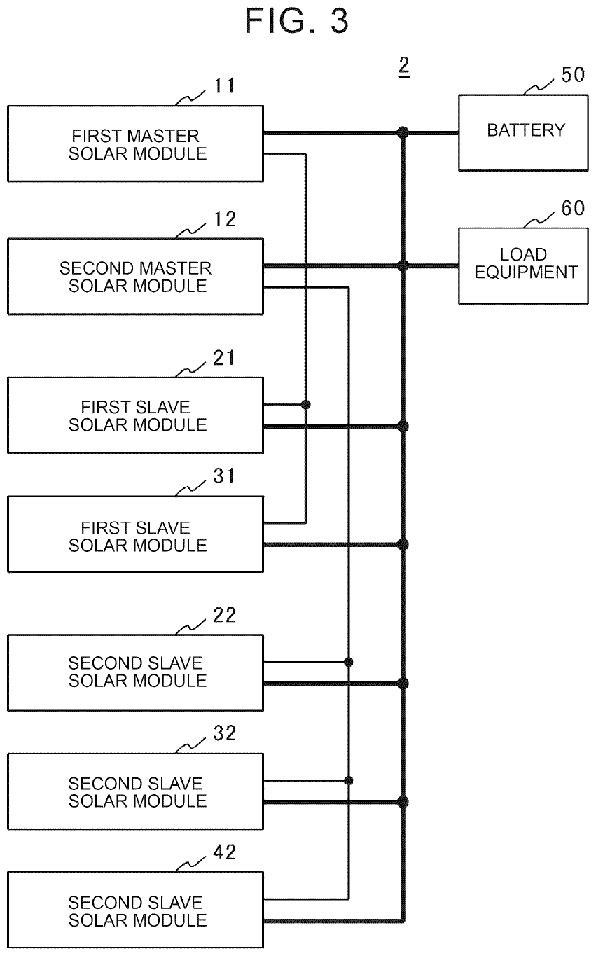

In the solar charging system 1 of FIG. 1, the operation of the two slave solar modules 20 and 30 is controlled by the master solar module 10. However, the number of slave solar modules controlled by the master solar module 10 is not limited thereto. Also, as illustrated in the solar charging system 2 of FIG. 3, there may be a plurality of master solar modules that control the slave solar modules. In FIG. 3, the master solar panel included in the first master solar module 11 and the slave solar panels included in the first slave solar modules 21 and 31 may have a correlation in a solar radiation situation. In addition, the master solar panel included in the second master solar module 12 and the slave solar panels included in the second slave solar modules 22, 32, and 42 may have a correlation in a solar radiation situation.

In addition, in the solar charging system 1 of FIG. 1, only the master solar module 10 is provided with a sensor (sensor 103) for detecting the physical quantity of the solar panel. However, each of the slave solar modules 20 and 30 may be provided with a sensor that only detects information irrespective of power generation control of the solar panel. For example, the slave solar modules 20 and 30 may be provided with a temperature sensor for measuring the temperature of the environment in which the solar panel is installed.

### Control

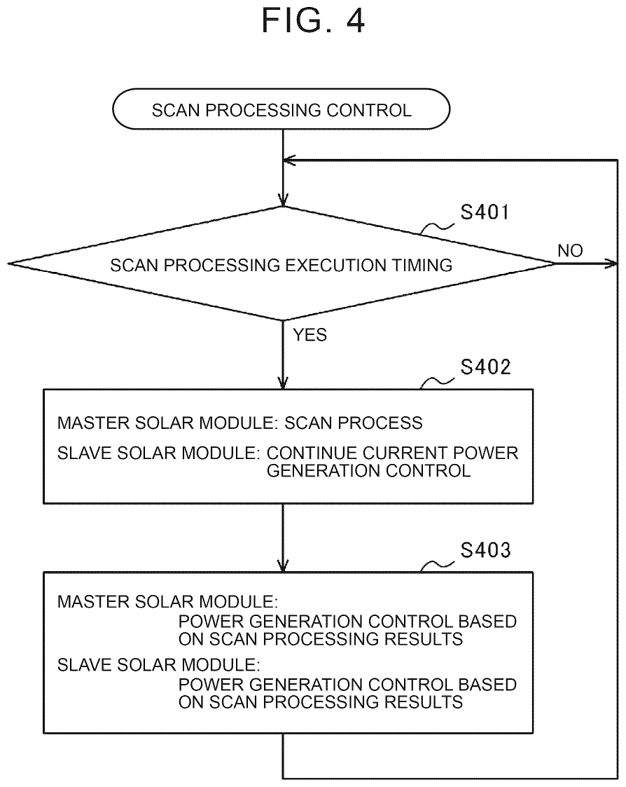

With further reference to FIG. 4, the control performed in the solar charging system 1 including the master solar module 10 and the slave solar modules 20 and 30 will be described. FIG. 4 is a flowchart showing a procedure of scan process control executed by the solar charging system 1 according to the present embodiment. The scan process control illustrated in FIG. 4 is started, for example, when the solar charging system 1 is activated, and is repeatedly executed until the solar charging system 1 is stopped.

### S401

The instruction unit 104 of the master solar module 10 determines whether or not the timing for executing the scanning process of the master solar panel 101 has come. This timing can be given in advance in a fixed manner so that the scanning process can be executed periodically. When the instruction unit 104 determines that the timing for executing the scanning process of the master solar panel 101 is reached (S401, Yes), the process proceeds to S402.

### S402

The master power generation control unit 102 of the master solar module 10 performs scanning processing of the master solar panel 101 based on an instruction given from the instruction unit 104. On the other hand, the slave power generation control unit 202 of the slave solar module 20 and the slave power generation control unit 302 of the slave solar module 30 continuously perform the power generation control of the slave solar panels 201 and 301 according to the current voltage command value. When the master power generation control unit 102 performs the scanning process on the master solar panel 101, the process proceeds to S403.

### S403

The instruction unit 104 of the master solar module 10 instructs the master power generation control unit 102 to perform control (voltage command value) based on the result of the performed scan processing. In response to this instruction, the master power generation control unit 102 performs power generation control of the new master solar panel 101 based on the result of the scanning process. Also. The instruction unit 104 also instructs the slave power generation control unit 202 of the slave solar module 20 and the slave power generation control unit 302 of the slave solar module 30 to perform control (voltage command value) based on the result of the performed scan processing. In this instruction, it is desirable to reflect the amount of control that is different between the master solar panel 101 and the slave solar panels 201 and 301 based on the normal direction, curvature, light transmittance, light attenuation, and the like of the surface of the solar panel that is known in advance. In response to this instruction, the slave power generation control unit 202 performs power generation control of the new slave solar panel 201 based on the result of the scanning process. Further, in response to this instruction, the slave power generation control unit 302 performs power generation control of the new slave solar panel 301 based on the result of the scanning process. When the power generation control of the respective solar modules is performed, the process returns to S401.

### Operations and Effects

A solar charging system according to an embodiment of the present disclosure includes a plurality of solar modules correlated with solar radiation conditions. Among a plurality of solar modules, only the main solar module (master) is provided with a sensor for acquiring the power generation state of the solar panel and an instruction unit for instructing the power generation control of the solar panel based on the power generation state acquired by the sensor. Further, among the plurality of solar modules, a slave solar module (slave) controls the power generation of the solar panel based on an instruction from an instruction unit of the main solar module.

With such a configuration, the indication of the power generation control of the solar panel in the main solar module (master) can be shared by several slave solar modules. Therefore, in the secondary solar module, it is possible to reduce the number of components such as sensors configured for power generation control of the solar panel. Therefore, it is possible to reduce the cost and scale of the solar charging system.

### APPLICATION EXAMPLE

Note that, in a configuration including a plurality of master solar modules as in the solar charging system 2 illustrated in FIG. 3, it is also possible to perform power generation control of an applied solar panel described below.

For example, in a configuration including the first master solar module 11 and the second master solar module 12, a case where an abnormality such as a failure occurs in the sensor of the first master solar module 11 will be considered. In such a case, the control command of the second master solar module 12 may be controlled so as to be applicable to the first slave solar modules 21 and 31 under the control of the first master solar module 11 in which the abnormality has occurred. In this control, it is necessary to electrically connect the control output of the first master solar module 11 and the control output of the second master solar module 12 via a switching element or the like. In addition, it is desirable that appropriate power generation control be performed in accordance with a difference between the solar radiation situation with respect to the first master solar module 11 and the solar radiation situation with respect to the second master solar module 12. For example, according to the difference in the solar radiation situation, by multiplying the control command to be applied by a predetermined coefficient or giving a predetermined weighting, it is adjusted so that appropriate power generation control is performed. The coefficient and the weighting can be set based on differences in the temperature of the solar panel, the actual generated electric power, the place where the solar panel is disposed, and the like.

An embodiment of the present disclosure has been described above. The present disclosure can be regarded as a solar charging system, a method executed by the solar charging system, a program for executing the method, a computer-readable non-transitory recording medium storing the program, a vehicle equipped with the solar charging system, and the like.

The present disclosure is applicable to a solar charging system including a plurality of solar modules.

What is claimed is:

1. A solar charging system comprising a plurality of solar modules configured to generate electric power using sunlight, wherein:
at least one master solar module among the plurality of solar modules includes
a master solar panel,
a sensor configured to acquire a power generation state of the master solar panel,
an instruction unit configured to give an instruction for power generation control on the master solar panel based on the power generation state acquired by the sensor, and
a master power generation control unit configured to control power generation of the master solar panel in accordance with the instruction from the instruction unit; and
each slave solar module other than the master solar module among the plurality of solar modules includes
a slave solar panel, and
a slave power generation control unit configured to control power generation of the slave solar panel by using an instruction from the instruction unit of the master solar module.

2. The solar charging system according to claim 1, wherein the master solar module and the slave solar module in which the slave power generation control unit is instructed by the instruction unit have a correlation in terms of a solar radiation situation between the master solar panel and the slave solar panel.

3. The solar charging system according to claim 2, wherein a state with the correlation in terms of the solar radiation situation includes a state in which how the sunlight impinges on the master solar panel and how the sunlight impinges on the slave solar panel are identical to each other or are analogous to each other within a predetermined range.

4. The solar charging system according to claim 2, wherein a state with the correlation in terms of the solar radiation situation includes a state in which how the sunlight impinges on the slave solar panel is presumable based on how the sunlight impinges on the master solar panel.
